(19) United States
(12) Patent Application Publication
(10) Pub. No.: US 2002/0044264 A1
(43) Pub. Date: Apr. 18, 2002

(54) Optical lens module adjustable in two dimensions

(76) Inventor: Chang-Hsing Lu, Chung-Li Shih (TW)

Correspondence Address: J.C. PATENTS INC., 4 Venture, Suite 250, Irvine, CA, 92618, US

(21) Appl. No.: 09/726,472

(22) Filed: Nov. 30, 2000

(30) Foreign Application Priority Data
Oct. 17, 2000 (TW) 89121632

(51) Int. Cl. G03B 3/00; G03B 21/14

(52) U.S. Cl. 353/101

(57) ABSTRACT

An optical lens module adjustable in two dimensions, to adjust an optical axis aligned with a projection light beam. An inside lens holder lens is used to support the optical lens module. The optical lens has an optical axis. A frame is installed inside of an enclosure of a projector in which the optical lens module is installed. There is a tolerance window between the frame and the enclosure of the projector to allow the inside lens holder to move within the tolerance window. The inside lens holder and the lens can move up and down inside of the frame. According to the adjustment in two different directions, the optical path of the projection can be adjusted identical to the projection light beam.

### CROSS-REFERENCE TO RELATED APPLICATION

This application claims the priority benefit of Taiwan application serial no. 89121632, filed Oct. 17, 2000.

### BACKGROUND OF THE INVENTION

1. Field of the Invention

The invention relates in general to an optical axis adjustment apparatus of an optical module. More particularly, this invention relates to an optical axis adjustment apparatus applied to projection display.

2. Description of the Related Art

The projection display is a complex optical instrument. For a color projection display, various optical elements are included. First of all, an emitted light source is decomposed into three primary color lights, that is, read light, green light and blue light. According to the individual optical path, these three lights project on a projection screen via a projection lens. To understand the optical adjustment apparatus of a projection display, the internal structure of the projection display is described as follows. After the light source is decomposed into three primary color lights, using a beam splitter and a reflection mirror, these three primary color lights are directed into three different optical paths. Eventually, these three lights merge into a light beam through each liquid crystal panel, and project on the projection screen via the object lens. When the position of any of the optical device deviates from its original position, the quality of image projected on the screen is degraded.

Several conventional optical adjustment apparatus are provided. One of them is to adjust the lens in the optical apparatus. The adjustment of the lens is unidirectional only. That is, the lens cannot adjust the lens towards other directions to obtain a further improved image. In addition, although some equipment does have one or two lens adjustable in two directions to increase the degree of freedom in adjustment. However, as the shifting directions of the image and the lens are not identical, it is thus not easy for user to operate. Moreover, the number of lenses in the optical apparatus is too big that when only one of the lenses needs adjusting, other lenses are consequently adjusted.

### SUMMARY OF THE INVENTION

The invention provides an optical lens module adjustable in two dimensions. The positions of the object lens of the projection display in transversal and longitudinal directions without adjusting any of the internal lenses in the adjustment apparatus.

Therefore, the invention provides a simply mechanism to adjust and align the optical system of the projection display. The optical lens module can be adjusted the optical lens along two different directions perpendicular to its optical axis.

The optical lens module adjustable in two dimensions comprises at least a inside lens holder, a frame, a first direction adjustable device and a second direction adjustable device. The lens support is used to support the optical lens module. The optical lens module has an optical axis. The first direction adjustable device is disposed along a first direction, and second direction adjustable device is disposed along a second direction. For example, when the first direction is a transversal direction, and the second direction is longitudinal direction. By adjusting the second direction adjustable device, the optical lens module can shift along the second direction. The first direction and the second direction have a constant angle, for example, 90°.

The above optical lens module adjustable in two dimensions further comprises a plurality of flexible clips at a periphery of the frame, so that the frame and the inside lens holder can be firmly mounted on the enclosure of the optical apparatus. The number of the clips is preferably 4 located at four corners of the frame.

In another embodiment of the invention, an optical lens module adjustable in two dimensions adjusts an optical axis of the optical lens module to be identical to a projection light beam. The optical lens module comprises at least an inside lens holder, a frame, a first direction adjustable device and a second direction adjustable device. The inside lens holder is disposed in the frame. One side of the inside lens support is closely mounted to on the enclosure of the optical apparatus to hold the optical lens module. A bearing is located on top of the inside lens holder. The bearing is formed with a screw thread hole. A tolerant range is remained between the edges of two sides of the frame and the inner rim of the enclosure of the optical apparatus, so that the frame can shift in the enclosure within the tolerance range. A protrusion is formed on each of two adjacent edges of the enclosure.

Both the foregoing general description and the following detailed description are exemplary and explanatory only and are not restrictive of the invention, as claimed.

### BRIEF DESCRIPTION OF THE DRAWINGS

FIG. 1 is a stereogram of a part of an optical lens module adjustable in two dimensions;

FIG. 2 is a stereogram of an optical apparatus of an optical lens module adjustable in two dimensions;

FIG. 3 shows a front view of the optical lens module as shown in FIG. 1;

FIG. 4 shows a cross sectional view along the cutting line IV-IV in FIG. 2;

FIG. 5 shows a cross sectional view along the cutting line V-V in FIG. 2; and

FIG. 6 shows a cross sectional view of the optical lens module adjustable in two dimensions, so as to show the positions of the flexible clippers.

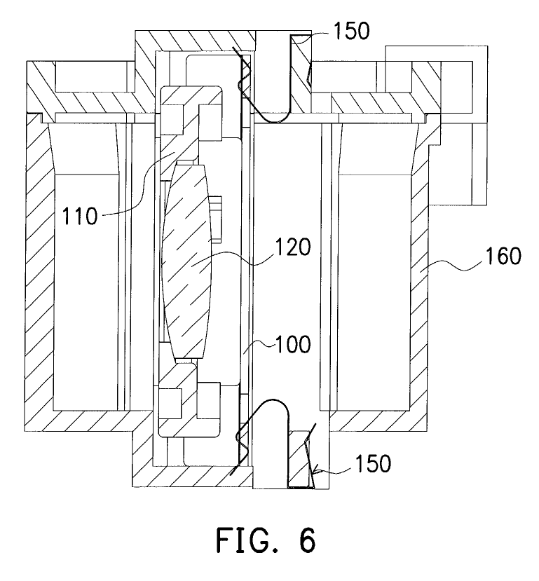

### DESCRIPTION OF THE PREFERRED EMBODIMENTS

The invention allocates two adjustment devices that can shift along the horizontal and the vertical directions to shift the lens along these two directions. As a result, the optical axis of the lens can be identical to the projection light beam. A good image quality can be obtained with a simplified adjustment procedure.

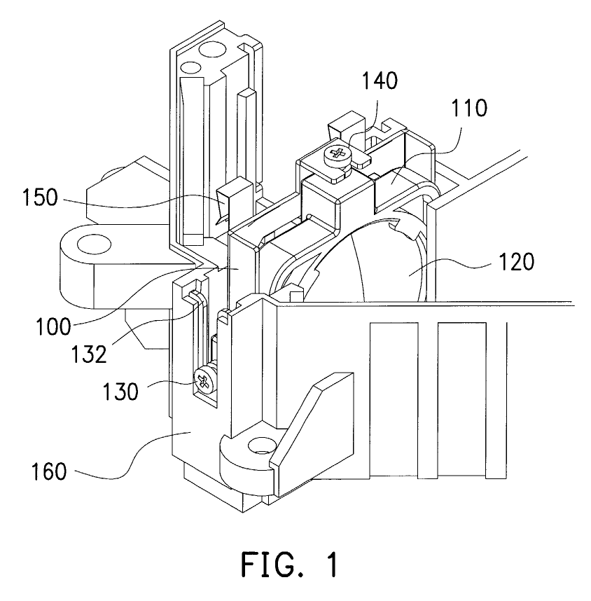

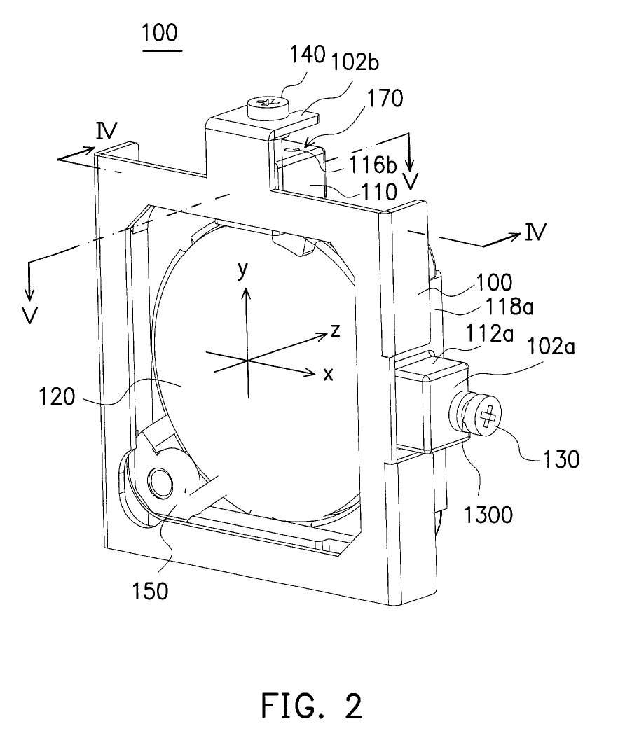

FIG. 1 illustrates a three-dimensional view of the optical lens module adjustable in two dimensions provided by the invention. The relationship between the optical lens module and the whole optical apparatus is depicted in FIG. 1. The dash line outlines the optical apparatus, and the solid line draws the optical lens module mounted in the optical apparatus. FIG. 2 shows a front view of the optical lens module. As shown in FIG. 2, the optical lens module comprises a frame 100, an inside lens holder 110, a first adjustable direction device 130 and a second direction adjustable device 140. A lens 120 is disposed in the inside lens holder 110. The lens 120 and the inside lens holder 110 are disposed at one side of the frame 100. By the first and the second direction adjustable devices 130 and 140, the lens 120 can be displaced towards the directions perpendicular to the optical path of the optical apparatus and the optical axis of the lens 120 (Z). In this embodiment, the frame 100 is made of a metal. It is appreciated that materials other than metal can also be used for forming the frame 100.

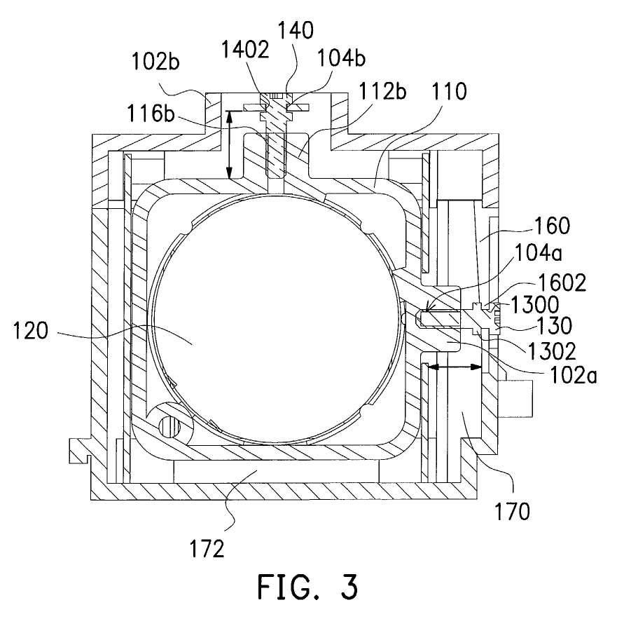

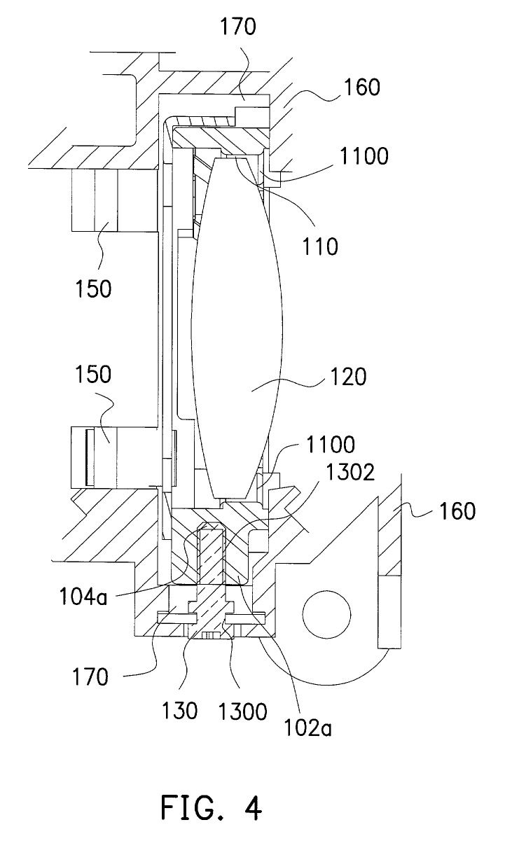

FIGS. 3 and 4 show a cross sectional view along the cutting line of IV-IV and V-V and a relationship between the optical apparatus and the optical lens module. In FIG. 3 and 4, the optical lens module makes the direction of the optical module lens (such as the Z direction in the figure) identical to the direction of projection light beam. The optical lens module comprises the inside lens holder 110, the frame 100, the first direction adjustable device 130, the second direction adjustable device 140 and at least a flexible clipper 130. The clipper 150 is located between an outer rim of the frame 100 and an enclosure 160 of the optical apparatus to locate the inside lens holder 110 between the frame 100 and the enclosure 160 of the optical apparatus.

The optical lens module or the lens 120 is supported by the inside lens holder 110. By the inside lens holder 110, the lens 120 can be firmly held without shifting away. The materials for forming the inside lens holder 110 and the enclosure 160 include plastic material such as bulk molding compound (BMC). On the outer rim of the inside lens holder 110, substantially a rectangular rim, two protrusions 1100 are formed to provide a better uniformity with the enclosure 160 of the optical apparatus. The inside lens holder 110 is located in the frame 110. There is an adjustable bearing 112b on the inside lens holder 110. The adjustable bearing 112b may have a screw thread hole 116b therein.

On one side of the frame, an adjustable bearing 102a is disposed. Similarly, the adjustable bearing 102a may have a screw thread 104a therein. A hole 104b is formed in the protrusion 102b and corresponding to the screw thread hole 116b. The protrusion 102a, the hole 104a are along the X-direction of FIG. 2. The adjustable bearing 112b, the protrusion 102b, the screw thread 116b and the hole 104b are along the Y-direction. The tolerance window 170 between edges of the frame 100 and the enclosure 160 of the projector in which the optical lens module is installed allows the frame 100 to move.

The first direction adjustable device 120 is installed along the first direction, that is, the X-direction perpendicular to the optical axis, Z-direction. The tolerance window 170 between the first direction adjustable device 130 and the enclosure 160 allows the first direction adjustable device 130 to be screwed in the hole 104a. Since the position of the first adjustable device 130 relative to the enclosure 160 is unchanged, while turning the screw thread 1302, the hole 104a is pushed to lead the frame 100 displace within the tolerance window 170. The optical lens module can thus move along the first direction (X-axis) by adjusting the first direction adjustable device 130. In this embodiment, as the edge of the screw has a recess 1300 corresponding to the hole 1602 of the enclosure 160, so that the first direction adjustable device 130 providing a rotation adjustment can be fixed in the enclosure.

The second direction adjustable device 140 is installed along the second direction, for example, Y-direction perpendicular to the optical axis, the Z-axis. Via the other hole 104b on the other protrusion 102b of the frame 100, the second direction adjustable device 140 is corresponding to the screw thread hole in the bearing 112b on the inside lens holder 110. The positions of the second direction adjustable device 140 and the hole 104b are fixed. While turning the second direction adjustable device 140, the thread 1400 leads the screw thread hole 116b of the bearing 12b to move forward or backward. The optical lens module (lens) 120 can thus move along the second direction (Y axis) by adjusting the second direction adjustable device 140. In this embodiment, the second direction adjustable device 140 includes a screw that has a recess 1402 at the edge. The recess 1402 is corresponding to the hole 104b of the frame 100. The first and the second directions have a fixed angle such as 90°. Similarly, the first direction adjustable device 130 includes a simple screw, for example.

FIG. 4 illustrates a cross sectional view of the optical lens module cutting along the line IV-IV in FIG. 2. The first direction adjustable device (the adjustable screw) 130 is engaged with the hole 116a in the bearing 112a of the inside lens holder 110. By turning the first direction adjustable device 130, the inside lens holder 110 can be shifted.

During the adjustment, using the first direction adjustable device 130 as an example, the inside lens holder 110 and the frame 100 are firmly engaged with each other. While using the adjustable devices 130 or 140 to adjust the position of the lens 120, the lens 120 will move along X- or Y-direction only without the displacement along Z-direction to ensure the precision of adjustment. When a screw is used as the first direction adjustable device 130, the screw 130 and the screw thread hole 104a are engaged. While threading the screw 130, the inside lens holder 110 is led to move within the tolerance window 170 to adjust the horizontal direction. Similarly, using the same mechanism the lens 120 is adjusted by the second direction adjustable device 140. The lens 120 can thus be adjusted within the tolerance window 172 in the vertical direction.

The invention provides two adjustable devices in two directions such as the adjustable screws 130 and 140. As a result, it is not necessary to adjust the lens inside of the projector. Only by adjusting the lens 120 in vertical and horizontal directions, the optical axis of the lens overlaps the projection light beam to obtain a good quality display. The optical axis of the lens is thus easily adjusted.

To closely engage the inside lens holder 110 and the frame 100, the adjustable devices 130 and 140 are adjusted to shift the position of the lens 120 along X- or Y-direction without any displacement in Z-direction. Therefore, the optical lens module is adjusted in two dimensions. The optical lens module further comprises several flexible clips 150 between the frame 100 and the enclosure 160 of the projector, so that the frame 100 and the inside lens holder 110 can be firmly engaged with the enclosure 160 to eliminate the tolerance between individual devices. The preferable number of the flexible clips 150 is 4, any they are preferably located at four corners.

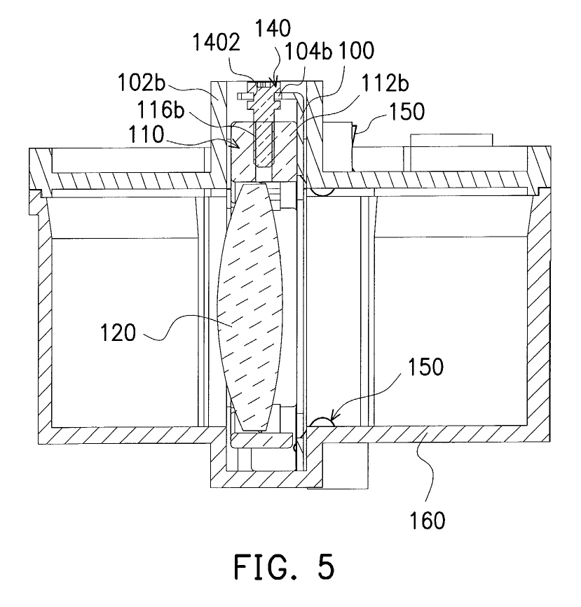

FIG. 5 shows a side view of the optical lens module as shown in FIG. 2 to illustrate the positions of the flexible clips. As shown in FIG. 5, the flexible clips 150 are disposed at a periphery of the frame 100 to firmly engage the frame 100 and the inside lens holder 110. The enclosure 160 is also coupled to the flexible clips 150 to provide a further steady support of the lens 120.

The invention thus includes the following advantages. The optical lens module adjusts the vertical and horizontal positions of an object lens used in the projector for correction without adjusting the positions of internal lenses. The correction mechanism is thus simplified.

The moving direction of the image projected by the projector is in the same direction of the adjustment of the lens, it is thus more user friendly. The user can thus make the correction more easily and straightforward.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An optical lens module adjustable in two dimensions, comprising:
a frame, located in a projector, the frame comprising a tolerance window between two sides thereof and an enclosure of the projector, so that the frame is allowed to move within the tolerance window inside of the enclosure;
an inside lens holder, located in the frame to support the optical lens module, the inside lens holder being able to move up and down inside of the frame, the optical lens module comprising an optical axis;
a first direction adjustable device, installed between the enclosure and the frame along a first direction vertical to the optical axis, to lead the frame and the inside lens holder to move along the first direction while being adjusted; and
a second direction adjustable device, installed between the frame and the inside lens holder along a second direction vertical to the optical axis, to lead the optical lens module to move along the second direction, wherein there is an angle between the first and second directions.

2. The optical lens module according to claim 1, further comprises at least a flexible clip disposed between the frame and the enclosure to firmly engage the inside lens holder with the enclosure.

3. The optical lens module according to claim 2, further comprises four flexible clips disposed between the frame and the enclosure at four corners of the frame.

4. The optical lens module according to claim 1, wherein the first and second direction adjustable devices comprise two screws.

5. The optical lens module according to claim 1, wherein the first direction is perpendicular to the second direction.

6. The optical lens module according to claim 1, wherein the inside lens holder is made of a plastic material with one side attached on the enclosure.

7. The optical lens module according to claim 1, wherein the enclosure is made of bulk molding compound.

8. An optical lens module adjustable in two dimensions to adjust an optical axis thereof identical to a light projected thereby, the optical lens module comprising:
a frame, installed inside of a projector, with a tolerance window between two sides thereof and an enclosure of the projector to allow the frame to move within the tolerance window, the frame comprising one protrusion on each of the two sides, and each protrusion further comprising an engaging hole;
a inside lens holder, installed in the frame to support the optical lens module, the inside lens holder being able to move up and down in the frame;
a first direction adjustable device, installed along a first direction vertical to the optical axis, the first direction adjustable device having one end with an engaging hole corresponding to one of the protrusion of the enclosure, while the engaging hole on the protrusion of the frame being corresponding to the protrusion of the enclosure, the protrusion allowing the frame to be threaded in, and when the protrusion is threaded in or out, the frame and the optical lens module moves along the first direction; and
a second direction adjustable device, installed along a second direction vertical to the optical axis, having one end with an engaging hole corresponding to an opening of the enclosure, and the other end corresponding to a thread hole of the inside lens holder, when the second direction adjustable device is threaded in or out, the optical lens module moves along the second direction, wherein there is a fixed angle between the first and the second direction.

9. The optical lens module according to claim 8, further comprising a plurality of flexible clips disposed between the frame and the enclosure to firmly engage the inside lens holder and the enclosure.

10. The optical lens module according to claim 8, wherein the first and the second direction adjustable devices comprise two screws.

11. The optical lens module according to claim 8, further comprises 4 flexible clips installed at four corners of between the frame and the enclosure.

12. The optical lens module according to claim 8, wherein the first and the second directions are perpendicular to each other.

13. The optical lens module according to claim 8, wherein the inside lens holder is made of a plastic material with one end attached on the enclosure.

14. The optical lens module according to claim 8, wherein the enclosure is made of bulk molding compound.
